(19) United States
(12) Patent Application Publication
(10) Pub. No.: US 2002/0002500 A1
(43) Pub. Date: Jan. 3, 2002

(54) Product sales server, product sales system, and sales method

(76) Inventor: Kuniaki Takahashi, Kanagawa (JP)

Correspondence Address: FROMMER LAWRENCE & HAUG LLP, 745 FIFTH AVENUE, NEW YORK, NY, 10151, US

(21) Appl. No.: 09/833,441

(22) Filed: Apr. 12, 2001

(30) Foreign Application Priority Data
Apr. 13, 2000 (JP) 2000-117201

(51) Int. Cl. G06F 17/60

(52) U.S. Cl. 705/26

(57) ABSTRACT

A product sales server for selling a product to consumers divided into a plurality of groups by using a network, comprising an order management means for receiving applications for purchase of the product from the consumers, verifying the identity of the consumers by identification information input from the consumers, and confirming the method of payment of the charge of purchase to the verified consumers and a charge calculation means for tabulating the number of the product purchasers for each group in accordance with group identification information showing the group to which consumers belong and setting discount rates for each group according to the number of purchasers, and a product sales system and sales method using the same.

### BACKGROUND OF THE INVENTION

1. Field of the Invention

The present invention relates to a product sales server, a product sales system, and sales method for selling products through a network.

2. Description of the Related Art

Conventionally, in retail sales of goods or provision of services to customers, in order to increase customers' desire to consume and increase business, companies have offered certain discount rates for the goods or services they supply under certain conditions when providing goods or services to the consumers. For example, the general practice has been to offer discount rates according to the quantity of the purchases of customers or to offer discount rates according to the number of times, the period, and other conditions of receipt of services.

Moreover, in recent years, along with the spread of the Internet, auction sites running auctions over the Internet have become popular. Due to this, the distribution of goods and service between individuals without going through retailers is becoming easier.

Summarizing the problems to be solved by the invention, there are limits to the conventional methods for retail sales and provision of services while offering discount rates to the customers. For example, it has been hard to set discount prices for goods and services for customers since in many cases it is difficult to predict the number of customers in advance.

Also, when purchasing goods or services through an auction site of the Internet, since the auction site provides the goods or service to the individual offering the highest bid, the winning individual bears the risk of paying an unexpectedly high price or people who really want something sometimes cannot obtain it because the price becomes overly high.

Further, while companies offering goods or services can supply goods or service through the auction sites on networks, suppliers find it difficult to make a profit unless selling a large number of the goods or services. Moreover, there is little merit to the suppliers if the auction sites are not that effective in the spread of the goods or service.

### SUMMARY OF THE INVENTION

An object of the present invention is to provide a product sales server, a product sales system, and sales method for providing goods or services through a network which divide consumers into groups and set discount rates according to the quantity of the goods or service purchased by each group so as to promote the consumers' desire to purchase and popularize the goods or service.

According to a first aspect of the present invention, there is provided a product sales server for selling a product to consumers divided into a plurality of groups by using a network, comprising an order management means for receiving applications for purchase of the product from the consumers, verifying the identity of the consumers by identification information input from the consumers, and confirming the method of payment of the charge of purchase to the verified consumers and a charge calculation means for tabulating the number of the product purchasers for each group in accordance with group identification information showing the group to which consumers belong and setting discount rates for each group according to the number of purchasers.

Preferably, the server further comprises a product information storage means for storing information about the product provided by provider of the product and a product information management means for managing the product information and sending the product information to the consumers through the network in response to requests of the consumers.

Alternatively, the server further comprises a customer information storage means for storing customer information including at least a customer identification number and a PIN number linked with each consumer and a customer information management means for managing the customer information and providing the customer information in response to a request of the order management means. Here, the order management means may include a customer verification means for having the customer information storage means retrieve a PIN number linked with a customer identification number in accordance with the customer identification number among the customer identification number and the PIN number input by the consumer when receiving an application for purchase from the customer, comparing the retrieved PIN number and the PIN number input from the consumer, and verifying the identity of the consumer.

Preferably, the order management means accepts applications for purchase of a product up to a preset deadline.

Preferably, the charge calculation means tabulates the number of purchasers of each group and publically discloses the results of tabulation over the network.

Alternatively, the charge calculation means calculates a delivery charge according to a method of delivery designated by each consumer.

Alternatively, the charge calculation means applies a discount rate to a representative of each group higher than the group members other than the representative.

According to a second aspect of the present invention, there is provided a product sales server for selling a product to consumers divided into a plurality of groups by using a network, comprising an order management means for receiving applications for purchase of the product from the consumers, verifying the identity of the consumers by identification information input from the consumers, and confirming the quantity of purchase of the product and the method of payment of the charge of purchase to the verified consumers and a charge calculation means for tabulating the quantity of purchase of the product for each group in accordance with group identification information showing the group to which consumers belong and setting discount rates for each group according to the quantity of purchases.

Preferably, the server further comprises a product information storage means for storing information relating to the product provided by the provider of the product and a product information management means for managing product information and sending the product information to the consumer through the network in response to a request of the consumer.

Alternatively, the server further comprises a customer information storage means for storing customer information linked with each consumer and including at least a customer identification number and a PIN number and a customer information management means for managing the customer information and providing the customer information in response to a request of the order management means. Here, the order management means may include a customer verification means for having the customer information storage means retrieve a PIN number linked with a customer identification number in accordance with the customer identification number among the customer identification number and the PIN number input by the consumer when receiving an application for purchase from the customer, comparing the retrieved PIN number and the PIN number input from the consumer, and verifying the identity of the consumer.

Preferably, the order management means accepts applications for purchase of a product up to a preset deadline.

Preferably, the charge calculation means tabulates the quantity of purchases of products of each group and publically discloses the results of tabulation over the network.

Alternatively, the charge calculation means calculates a delivery charge according to a method of delivery designated by each consumer.

Alternatively, the charge calculation means applies a discount rate to a representative of each group higher than the group members other than the representative.

According to a third aspect of the present invention, there is provided a product sales server for selling a product by using a network, comprising a sales method management means for determining at least a first sales method and a second sales method and assigning a first sales quantity for sale by the first sales method and a second sales quantity for sale by the second sales method in the products being sold and an order management means for receiving applications for products from users, obtaining purchase prices from users purchasing the product by the first sales method, determining the purchasers of the product in accordance with the purchase prices of the users, and delivering the product to the users purchasing by the first sales method at a time earlier than users purchasing the product by the second sales method.

Preferably, the first sales method is auction sales and the order management means determines the priority order of the users ordering the product by auction sales in accordance with the purchase prices submitted by the users and ends the sale by the first ales method when the total number of orders reaches the first sales quantity assigned by the sales method management means.

Preferably, the second sales method is group discount sales, and the order management means tabulates the quantity of orders for the product for each group to which users belong and sets discount rates for each group according to the result of tabulation for users ordering the product by the second sales method.

According to a fourth aspect of the present invention, there is provided a product sales server for selling a product by using a network, comprising an order management means for receiving applications for purchase of the product from users and a dividend management means for issuing a dividend based on a predetermined amount to users purchasing the product when the total profit obtained by the sale of the product reaches a preset target.

Preferably, the dividend management means issues the dividend to users purchasing products of the initial shipment of the products.

Alternatively, the dividend management means issues a dividend to the users purchasing the product by auction sales.

Alternatively, the dividend management means provides a discount service corresponding to the value of the dividend to the purchasers of the product.

Alternatively, the dividend management means issues a first dividend to the purchasers of the product when the total profit from the sale of the product reaches a preset first target and issues a second dividend to the purchasers of the product when the total profit reaches a predetermined second target.

According to a fifth aspect of the present invention, there is provided a product sales system for selling a product to a plurality of consumers by using a network, comprising a user terminal, connected to the network, by which a consumer desiring to purchase the product applies for a purchase, an order management means for receiving applications for purchase of the product from the consumers, verifying the identity of the consumers by identification information input by the consumers, and confirming the method of payment of the charge for the purchase to the verified consumers, and a charge calculation means for tabulating the number of the purchasers of the product in each group according to group identification information showing the group to which the consumers belong and setting discount rates for each group according to the number of the purchasers.

According to a sixth aspect of the present invention, there is provided a product sales system for selling a product to a plurality of consumers by using a network, comprising a user terminal, connected to the network, by which a consumer desiring to purchase the product applies for a purchase, an order management means for receiving applications for purchase of the product from the consumers, verifying the identity of the consumers by identification information input by the consumers, and confirming the method of payment of the charge for the purchase to the verified consumers, and a charge calculation means for tabulating the quantity of purchases of the product in each group according to group identification information showing the group to which the consumers belong and setting discount rates for each group according to the quantity of purchases of the product.

According to a seventh aspect of the present invention, there is provided a product sales system for selling a product by using a network, comprising a sales method management means for determining at least a first sales method and a second sales method and assigning a first sales quantity for sale by the first sales method and a second sales quantity for sale by the second sales method in the product to be sold and an order management means for receiving applications from users, obtaining purchase prices from users purchasing the product by the first sales method, determining the purchasers of the product in accordance with the purchase prices of the users, and delivering the product to the users purchasing by the first sales method at a time earlier than users purchasing the product by the second sales method.

According to an eighth aspect of the present invention, there is provided a product sales system for selling a product by using a network, comprising an order management means for receiving applications for purchase of the product from users and a dividend management means for issuing a dividend based on a predetermined amount to users purchasing the product when the total profit obtained by the sale of the product reaches a preset target.

According to a ninth aspect of the present invention, there is provided a product sales method by which a product sales server sales a product to a plurality of consumers by using a network, comprising a step of having the product sales server receive applications for purchase of the product from the consumers through the network, a step of verifying the identity of the consumers by identification information input from the consumers and confirming the method of payment of the charge of purchase to the verified consumers, and a step of tabulating the number of the product purchasers for each group in accordance with group identification information showing the group to which consumers belong and setting discount rates for each group according to the number of purchasers.

According to a 10th aspect of the present invention, there is provided a product sales method by which a product sales server sales a product to a plurality of consumers by using a network, comprising a step of having the product sales server receive applications for purchase of the product from the consumers through the network, a step of verifying the identity of the consumers by identification information input from the consumers and confirming the quantity of purchases of the product and method of payment of the charge of purchase to the verified consumers, and a step of tabulating the quantity of product purchases for each group in accordance with group identification information showing the group to which consumers belong and setting discount rates for each group according to the quantity of purchases.

According to an 11th aspect of the present invention, there is provided a product sales method by which a product sales server sales a product to a plurality of consumers by using a network, comprising a step of determining at least a first sales method and a second sales method and assigning a first sales quantity for sale by the first sales method and a second sales quantity for sale by the second sales method in the products being sold and a step of receiving applications for products from users, obtaining purchase prices from users purchasing the product by the first sales method, determining the purchasers of the product in accordance with the purchase prices of the users, and delivering the product to the users purchasing by the first sales method at a time earlier than users purchasing the product by the second sales method.

According to a 12th aspect of the present invention, there is provided a product sales method by which a product sales server sales a product to a plurality of consumers by using a network, comprising a step of receiving applications for purchase of the product from users and a step of issuing a dividend based on a predetermined amount to users purchasing the product when the total profit obtained by the sale of the product reaches a preset target.

### BRIEF DESCRIPTION OF THE DRAWINGS

These and other objects and features of the present invention will become clearer from the following description of the preferred embodiments given with reference to the accompanying drawings, in which:

FIG. 1 is a view of the configuration of a first embodiment of a product sales system according to the present invention;

FIG. 2 is a chart of an example of a customer database;

FIG. 3 is a chart of an example of a product database created in accordance with information of the products offered by the provider;

FIG. 4 is a chart of an example of an order list database;

FIG. 5 is a graph of discount rates set according to the number of purchasers of products in each group;

FIG. 6 is a chart of the operation of a product sales system when a group's representative applies for purchase of a product;

FIG. 7 is a chart of the operation of a product sales system when a group's participant applies for purchase of a product;

FIG. 8 is a view of the configuration of a second embodiment of a product sales system according to the present invention;

FIG. 9 is a graph of the purchasing price and the purchasing quantity;

FIG. 10 is a flow chart of the processing in the product sales system of the present embodiment;

FIG. 11 is a view of the configuration of a third embodiment of a product sales system according to the present invention;

FIG. 12 is a graph of the total profit of a product and the time of dividend; and

FIG. 13 is a flow chart of the processing in the product sales system of the present embodiment.

### DESCRIPTION OF THE PREFERRED EMBODIMENTS

First Embodiment

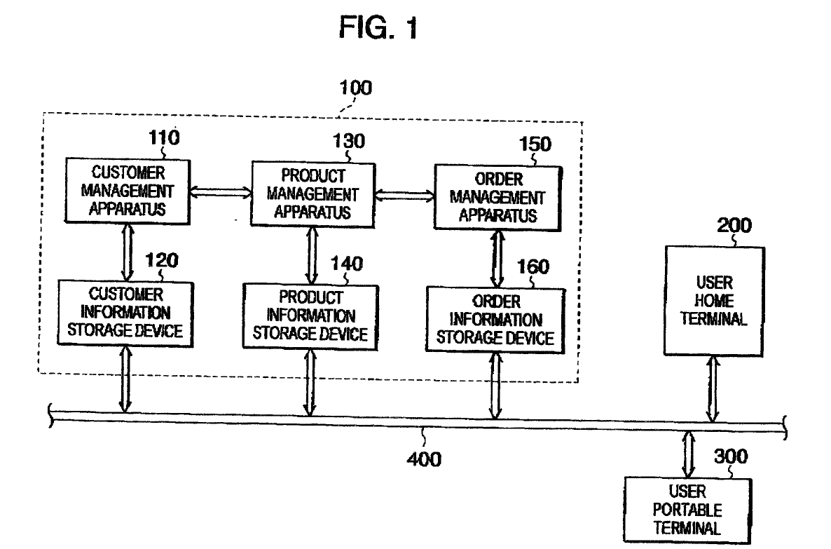

FIG. 1 is a view of the configuration of a product sales system of a first embodiment of the present invention.

As illustrated, the product sales system of the present embodiment is comprised of a provider server 100, a user home terminal (home terminal) 200, a user portable terminal 300, and a network 400. In FIG. 1, only one user home terminal 200 and one user portable terminal 300 are shown, but a plurality is also possible.

The provider server 100 is a network server managed and operated by a provider of certain goods or services. It provides the users with information on the goods or services, manages customer information, and manages orders from the users. For example, a party providing certain goods or services (hereinafter referred to as products) (hereinafter referred to as a product provider or only a provider) announces a new product or existing product through the network or another media or advertising means and solicits purchasers of the product from the consumers while setting a predetermined deadline. It fields inquiries made through the network from potential purchasers of the product (hereinafter referred to users) and, when a user applies for purchase of the product, provides the corresponding goods or service to the user or arranges for provision of the goods or services.

The user home terminal 200 is a home terminal of a consumer using a product provided by the provider and is comprised of a user interface, a controller with a necessary data processing function, and a communications function for connecting with the provider server through the network and sending and receiving information. The user home terminal 200 is comprised of a computer that can connect with a telephone network, cellular telephone network, or dedicated line through a modem etc. for communicating with other terminals or a server, a set top box, and other terminal equipment. The consumer can access the provider server 100 through the user home terminal 200 to obtain the necessary information about a product, search for a desired product, and apply for purchase.

The user portable terminal 300 is a portable terminal, for example, a cellular telephone, provided with the function of accessing other information terminals and an information server etc. through a network. A consumer using a product provided by the provider can use the portable terminal 300 to access the provider server 100 through the network 400 and can use the portable terminal 300 to authenticate itself as the customer, read information, view for example information about the products provided, is own customer information registered in the customer database, etc., and write information, for example, input new information in the customer database, order a product, etc.

The network 400 consists of communication lines connected between the provider server 100 and the user home terminals 200 or the user portable terminals 300. In the present embodiment, the type of the network 400 is not particularly limited. It may be any of a usual telephone network, wireless cellular telephone network, or Internet access through a dedicated line.

Next, an explanation will be made of the configuration of the provider server 100.

As shown in FIG. 1, the provider server 100 is comprised of a customer management apparatus 110, a customer information storage device 120, a product management apparatus 130, a product information storage device 140, an order management apparatus 150, and an order information storage device 160.

The customer management apparatus 110 manages customer information of users receiving products. The customer management apparatus 110 receives applications for registration from the users through the network 400, registers the users' personal information, and then sends customer identification numbers (customer IDs) to the users who clear certain conditions. The customer personal information includes, for example, a user's password, name, address, telephone number, the serial number of the user's home terminal, etc. and, when a user applies for purchase of a product, includes the method of settlement of the charge for the purchased item, for example, a bank account number, credit card number, or information indicating payment by collection agents. The customer management apparatus 110 receives applications for registration from users, creates a customer database according to the information input by the users, and stores the information in the customer information storage device 120.

The customer information storage device 120 stores the customer database created by the customer management apparatus 110. The customer database includes, in addition to the above customer personal information, the state of use of provided products by the user up to now, for example, for example, the purchased items, the purchasing dates, the purchased quantities, and records of collection agents (payment through telephone companies or convenience stores). The customer information stored in the customer information storage device 120 is created, updated, or deleted according to an instruction from the customer management apparatus 110. Further, according to an instruction from the customer management apparatus 110, information on a predetermined customer may searched for from the customer database and information on a customer corresponding to the search conditions may be read out and transferred to the customer management apparatus 110 and the order management apparatus 150 or transferred to other terminals or the server through the network 400.

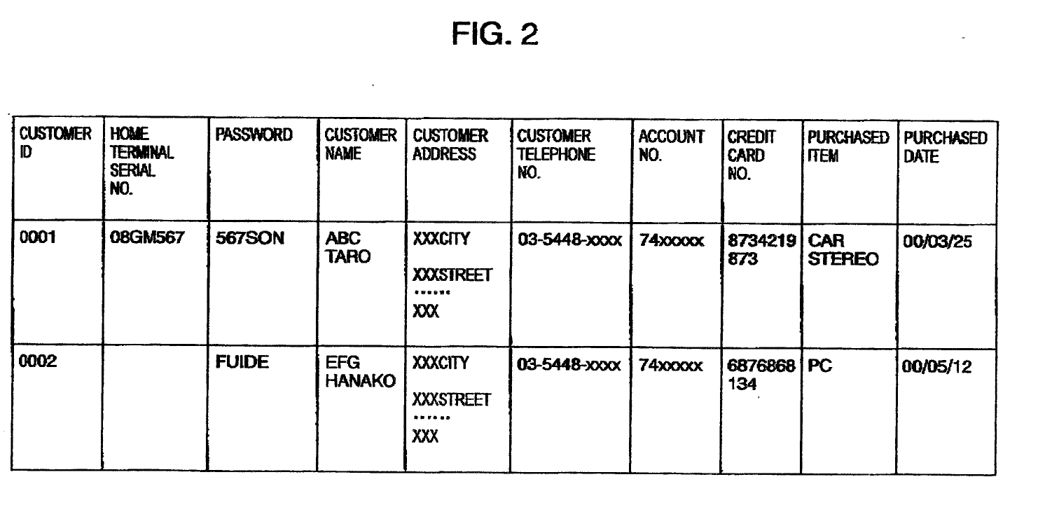

FIG. 2 shows an example of the customer database stored in the customer information storage device 120. Below, an explanation will be given of the content of the customer database.

The customer ID is an identification number or symbols given to each registered customer for identifying the customer. Note that customer registration may be set by the provider side by automatic registration where applying customers are unconditionally registered and by examination where a certain check is conducted and users who satisfy certain conditions are registered. In the automatic registration system, registration is automatically conducted and a customer ID assigned for all applications for registration from users. On the other hand, in the examination system, when there is an application for customer registration from a user, the customer management apparatus 110 conducts a check of the customer based on personal information provided from the customer or information collected from other routes of information and allows registration and assigns a customer ID only to users meeting certain conditions.

Note that when a large number of customers are divided into a plurality of groups, a user applying for registration as the representative of a group is registered by the examination system. For example, only users who meet certain conditions set by the service provider are registered as group representatives. On the other hand, it is possible to register users applying for purchase of products as group members by the automatic registration system.

The “user home terminal serial number” is the manufacturing serial number of the user home terminal owned by a user and is used for identifying whether the user is the customer who purchased the user home terminal or not.

The “name” is the name of a user with a customer ID.

The “address” is an address registered by a customer with a customer ID and is registered and stored as the delivery address of products.

The “telephone number” is the telephone number of a user with a customer ID.

The “bank account number” is the number of a bank account which a customer with a customer ID will use for paying the charge of the product.

The “credit card number” is the number of the credit card which a customer with a customer ID will use for paying the charge of the product.

The “purchased items” are the names of related products previously purchased by a user with a customer ID.

The “purchasing dates” are the dates of application for purchase of related products.

The product management apparatus 130 manages information of the products provided by the provider. The product management apparatus 130 assembles the information on the types of products provided, prices, stock, stock period, period for receiving applications for purchase, etc. to create a product database and stores it in the product information storage device 140. Further, the product management apparatus controls the updating, addition to, and deletion from the product database stored in the product information storage device 140. When there is a request from a user for information on a product, the product information storage device 140 reads out certain product information and sends it to the user.

The product information storage device 140 stores the product database created by the product management apparatus 130. The content of the product database is updated, added to, or deleted from according to the instruction of the product management apparatus 130. Further, it is possible to search for certain product information in response to a user's request, send the information of the corresponding product to the product management apparatus 130, or transmit it through the network 400 directly to the user's terminal.

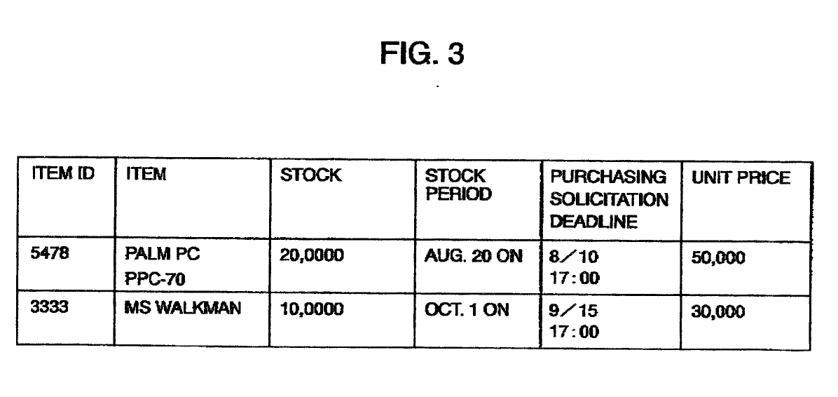

FIG. 3 shows an example of the product databases stored in the product information storage device 140. Next, the content of the product database will be explained.

The “item ID” is the identification number or symbols assigned to products for identifying the products to be provided.

The “item” is information expressing the name of a product to be provided.

The “stock” is information showing how many products can be provided.

The “stock period” is information showing the period for which it is planned that products can be actually provided.

The “stock location” is information showing the location which can provide products.

The “unit price” is information forming guidelines of the sales price of products.

The “purchase solicitation deadline” is information showing the date of the final deadline for solicitation of purchasers for products.

The order management apparatus 150 manages orders for product purchases from users. The order management apparatus 150 receives orders for products from users through the network 400, creates an order list database according to the content of orders of users, and stores it in the order information storage device 160. Moreover, the order management apparatus 150 can update, add to, or delete from the order list database of the order information storage device 160 and can read the content of the order list database from the order information storage device 160, sort the information in a certain order, and output it to the network 400. Moreover, the order management apparatus 150 can connect to the customer management apparatus 110, the customer information storage device 120, the product management apparatus 130, and the product information storage device 140 to obtain the necessary information.

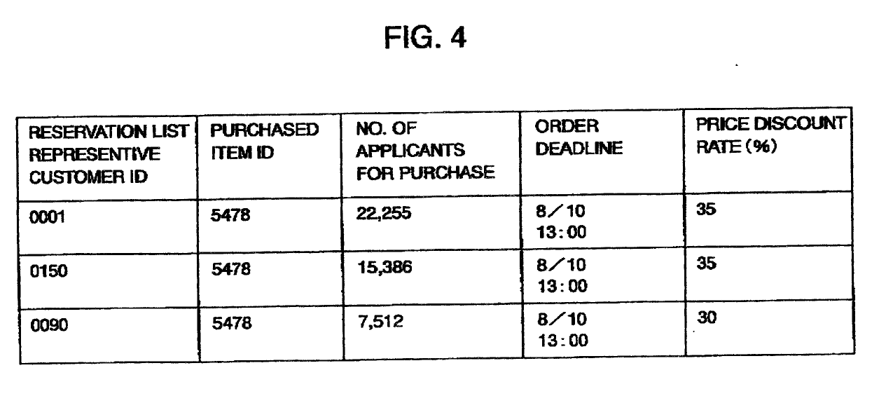

FIG. 4 shows one example of the order list database stored in the order information storage device 160. Next, the content of the order list will be explained.

As illustrated, the order list database contains the order group representative IDs, purchased item IDs, number of applicants for purchase, order deadline, and price discount rate corresponding to numbers of applicants in correspondence.

The “group representative ID” is the customer ID of the user serving as the representative of a group of potential purchasers of a product.

The “purchased item ID” is the ID number of product ordered by a user with a group representative ID. This ID number is the same as the item ID of the product to be provided contained in the product database stored by the product information storage device 140.

The “number of applicants for purchase” is the number of potential purchasers in a group comprised of a plurality of users assembled under a user with a representative ID.

The “order deadline” is the date of the final deadline for assembling and submitting a number or borderers of a group.

The “price discount rate” is the price discount rate corresponding to the number of borderers of a group.

Next, the operation when selling a product in the product sales system shown in FIG. 1 will be explained. The product provider publicizes and advertises a product provided through the network 400 or other medium, sets a purchasing deadline for the consumers, and solicits purchasers.

Users are divided into a plurality of groups. Each group is formed under a representative of the group. For example, a user who purchased a user home terminal 200 is registered as the representative of a group. Note that groups are formed and maintained by the individual effort of the representatives of the groups. For example, the group representatives publicize groups and solicit membership through the network 400. They can explain to the consumers the fact that when there are a large number of purchasers in a group, the product can be purchased by a more advantageous discount rate and promote participation in the group to increase the number of persons in the group.

The representative of each group collects the potential purchasers of a certain item and accesses the provider server 100 through the network 400 to apply for purchase. In this case, the representative of the group uses his own user home terminal 200 to access the provider server 100 through the network 400 and verify that he is who he says he is the serial number of his own by user home terminal, customer ID, and password. For this verification, for example, the group representative uses his own home terminal 200 to input his customer ID and password. At the provider server 100, the customer management apparatus 110 verifies that the customer is who he says he is based on information such as the password associated with the customer ID from the customer database stored in the customer information storage device 120. A customer can also be verified by obtaining documents and checking the documents at the provider side.

Further, a group representative or a user other than the representative can apply for a product by his portable terminal 300. In this case, a user desiring purchase of a certain product uses his portable terminal 300 to access the order management apparatus 150 of the provider server 100 through the network 400 and apply for a product. Note that when making an application, a user transmits the customer ID of the representative of the group to he belongs through the portable terminal 300 and the network 400 to the order management apparatus 150. The order management apparatus 150 tabulates the applications for purchase for the groups indicated by the customer IDs of the group representatives input in the applications for purchase.

The order management apparatus 150 tabulates the quantities of purchase for each product for each group in real time, assembles these in descending order of the number of purchasers of a group or number of purchases of a product, creates a ranking of the number of purchasers by each group or quantities of purchase of the products, and publically announces these through the network 400. It is also possible to disclose the contact addresses of the representatives at the desire of the group representatives.

Group discount rates are calculated in accordance with the number of purchasers for each item in each group or the quantities of purchases of products at the solicitation deadline. The products are provided to the purchasers at the discounted prices after application of the calculated discount rates to the standard prices of the products. The discount rates are set higher the greater the number of purchasers or the greater the quantity of the products purchased. Products are provided to the group representatives at the highest discount rates. Further, incentives can also be added such as delivery of products to users ordering products through user home terminals 200 on a priority basis before release in retail stores.

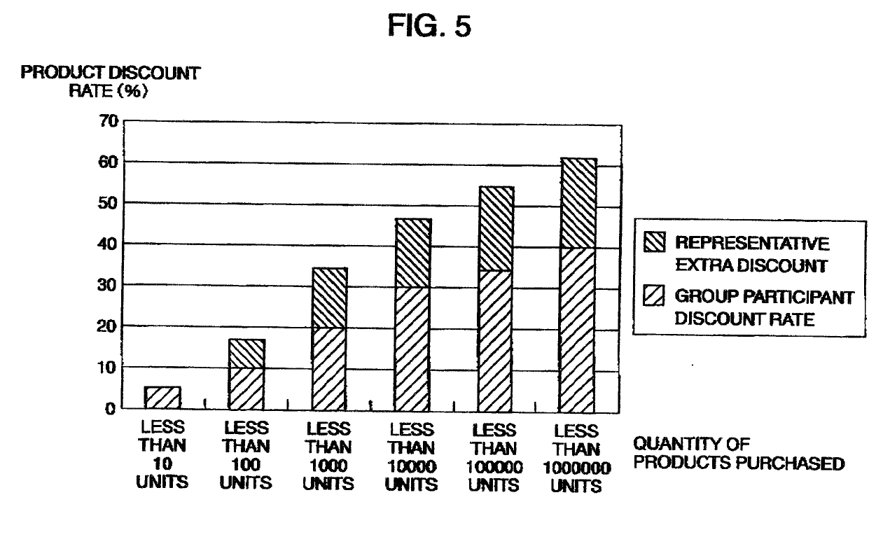

FIG. 5 shows the discount rate set according to the quantity of purchases of products for each group and the extra discount rate for group representatives. As illustrated, the discount rate is set differently according to the quantity of purchases of a group. The greater the quantity of purchases of products of a group, the higher the discount rate is set. Further, an extra discount rate from other group members is given to group representatives.

Consumers without user home terminals 200 can be informed of methods for application for registration, for example, the methods of application by telephone, cellular telephone, mail, the Internet, and so on. For example, it is possible to send new product information and notifications of solicitation of purchasers by means such as delivery by cellular telephone, direct mail, e-mail, homepages, etc. It is therefore possible to broadly publicize products and stimulate the desire of consumers for purchase.

Note that in the above product sales system, the customer management apparatus 110 and customer information storage device 120, the product management apparatus 130 and product information storage device 140, and the order management apparatus 150 and order information storage device 160 were described as being serially connected, but the configuration of the product sales system of this embodiment is not limited to the above configuration. The components of the system may also be connected to the network 400 in parallel. Further, the customer management apparatus 110, the customer information storage device 120, the product management apparatus 130, the product information storage device 140, the order management apparatus 150, and the order information storage device 160 can all be realized on the same computer.

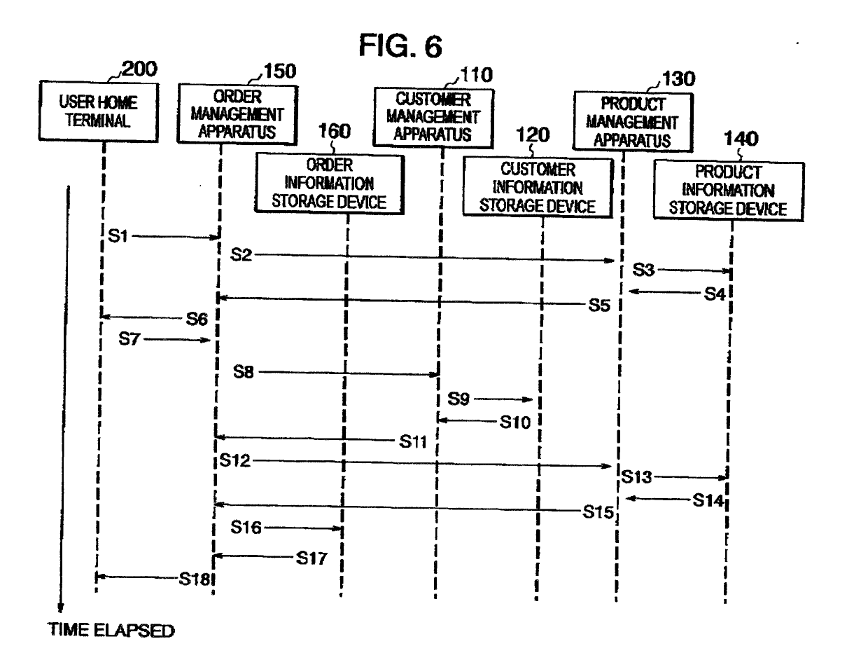

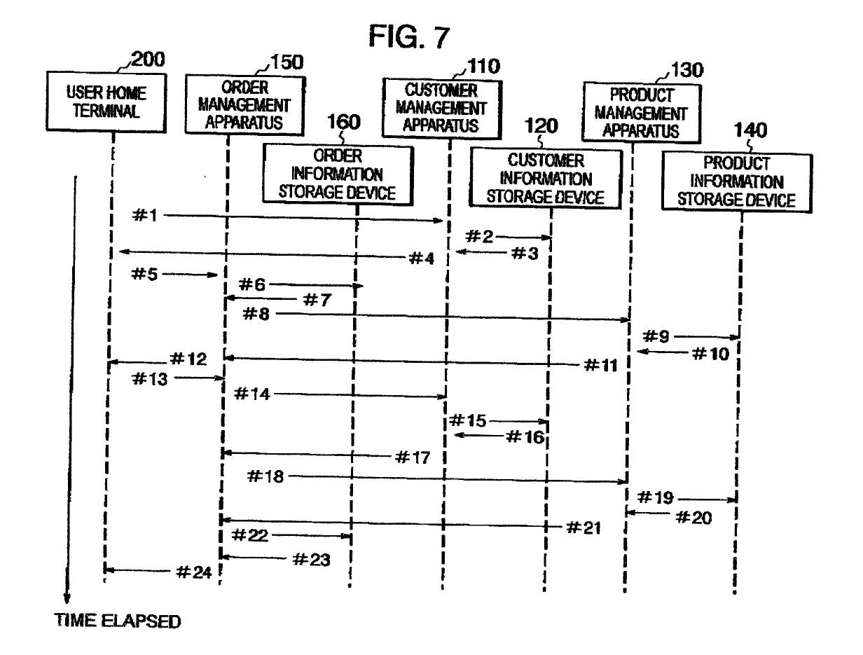

FIG. 6 and FIG. 7 show the flow of information at the time of operation in the product sales system of the present embodiment. Next, the operation of the product sales system of the present embodiment will be explained in detail with reference to FIG. 6 and FIG. 7.

Here, it is assumed that the customer database and the product database are created in advance by the customer management apparatus 110 and the product management apparatus 130 and are stored in the customer information storage device 120 and the product information storage device 140, respectively.

First, the product provider publically discloses the information on all of the products to be provided and delivers the deadline for solicitation of reservations for orders and the discount rates for products in accordance with the numbers of purchasers by advertisements or a network 400 or directly to registered user home terminals 200 to broadly distribute product information.

FIG. 6 shows the flow of processing when a user with a user home terminal 200, that is, a group representative, uses his own user home terminal 200 to apply for purchase of a product.

Step S1: First, a user owning a user home terminal 200 uses the user home terminal 200 to access the order management apparatus 150 through the network 400 to apply for purchase of the product.

Step S2: The user home terminal 200 transmits an instruction of a desire for purchase of a product to the order management apparatus 150. Further, the order management apparatus 150 accesses the product management apparatus 130.

Step S3: The product management apparatus 130 transmits a request for obtaining product information stored in the product database to the product information storage device 140.

Step S4: The product information storage device 140 sends back the data on the provided products, for example, a list of products, to the product management apparatus 130.

Step S5: The product management apparatus 130 transmits the list of products sent from the product information storage device 140 to the order management apparatus 150.

Step S6: The order management apparatus 150 transmits the list of products obtained from the product management apparatus 130 to the user home terminal 200 through the network 400. Note that the list of products sent to the user home terminal 200 at least includes the item IDs of the products and the names of the products corresponding to the item IDs. It is most desirable that a simple explanation about each product be attached.

Step S7: The owner of the user home terminal 200 views the list of the products transmitted and selects the product to purchase. When applying for purchase of a product, it transmits the purchased product ID, the customer ID, and the serial number of the user home terminal through the user home terminal 200 to the order management apparatus 150.

Step S8: The order management apparatus 150 transmits the input customer ID to the customer management apparatus 110 and requests the provision of personal information corresponding to the customer ID. Here, the information transmitted from the order management apparatus 150 to the customer management apparatus 110 includes at least the customer ID and password as the information for identifying the customer.

Step S9: The customer management apparatus 110 requests a search of the password corresponding to the customer ID at the customer database based on the customer ID input to the customer information storage device 120 in response to a request from the order management apparatus 150.

Step S10: The customer information storage device 120 searches through the customer database by the designated customer ID in response to a request from the customer management apparatus 110, extracts the password corresponding to that customer ID, and returns it to the customer management apparatus 110.

Step S11: The customer management apparatus 110 compares the password found by the customer information storage device 120 and the password input by the user from the user home terminal 200 to verify that the user is the customer with the customer ID. When the user is verified as being the holder of the customer ID, the result is sent to the order management apparatus 150.

Step S12: When the order management apparatus 150 verifies the user by the customer management apparatus 110, it transfers the order data from the user to the product management apparatus 130.

Step S13: The product management apparatus 130 accesses the product information storage device 140 and searches for the product information based on the item ID of the ordered product.

Step S14: The product information storage device 140 updates the content of the product database showing the information of the products provided as needed and then send back the found product information based on the item ID of the ordered product to the product management apparatus 130.

Step S15: The product management apparatus 130 checks that the stock of the produced ordered by the user is larger than the ordered quantity and transmits a sign indicating if the order has been approved to the order management apparatus 150 accordingly.

Step S16: In the order is approved, the order management apparatus 150 sends the customer ID of the user placing the order and the item ID of the ordered product to the order information storage device 160.

Step S17: The order information storage device 160 updates the order list database in accordance with the customer ID and the item ID of the product input from the order management apparatus 150. Here, it adds information on the ordered product, for example, the item of the ordered product, the quantity of the orders for the item, and other information to the order list database, calculates the past order of the group represented by a customer having a customer ID, and updates the order information of the group. When the order information storage device 160 finishes updating the order list database, it notifies the order management apparatus 150 of the completion of updating of the database.

Step S18: When the order is approved, the order management apparatus 150 sends this information on the approval of the order to the user home terminal 200 through the network 400.

A user receiving a notification of approval of an order uses a forum on the Internet, a homepage, e-mail, and other existing infrastructure or a home terminal forum provided in the user home terminal 200 to solicit potential purchasers of the product. The potential purchasers are always informed of the user's customer ID as their representative. The group representative receives a larger discount rate the greater the number of group members he assembles, so works to solicit as many potential purchasers as possible.

Next, an explanation will be given of the processing in the case where general consumer not registered in the provider server 100, that is, a person not owning a user home terminal 200 or a potential purchaser not having a customer ID, uses a cellular phone, a laptop computer with a network communication function, or other portable terminal to place an order for a product.

Here, the explanation will be made of the case where a consumer ordering a product obtains the customer ID from a user already having a customer ID, for example, the group representative, and orders a product as a member of the group of the representative. Note that the user is not registered, at the provider server 100, so the customer information storage device 120 of the provider server 100 does not store personal information relating to the user. Therefore, when the provider server 100 receives an order from this user, first it uses the customer management apparatus 110 to register the personal information of the user.

FIG. 1 is a view of the processing when a user not owning a user home terminal 200 uses the use portable terminal 300 to apply for purchase of a product.

This processing will be explained in detail below with reference to FIG. 7.

Step #1: First, the user uses the user portable terminal 300 to access the customer management apparatus 110 and register personal information. Further, a consumer not having a user portable terminal can have the provider register the personal information in the customer database by mailing documents.

Step #2: The customer management apparatus 110 issues a customer ID and password to the user and inputs information including the customer's name, address, telephone number, method of settlement of the charge of the purchased product, the number of the bank account for settlement, credit card number, etc. to the customer database. Note that the method of settlement of the charge of the product may designate collection through the carrier of the cellular telephone or convenience shop.

Step #3: The customer information storage device 120 adds personal information of the customer newly registered in the customer database, for example, information including the customer ID and password, in the database and returns the personal information of the customer to the customer management apparatus 110 according to the instruction from the customer management apparatus 110.

Step #4: The customer management apparatus 110 sends the information including the customer ID and password to the user portable terminal 300.

Step #5: When a user registered as a customer places an order, it uses the user portable terminal 300 to access the order management apparatus 150. It sends its own customer ID obtained by registration at the order management apparatus 150, the customer ID of the group representative, and information about the ordered product.

Step #6: The order management apparatus 150 accesses the order information storage device 160 based on the ordered product and the customer ID of the group representative.

Step #7: The order information storage device 160 extracts a list of the purchased products of the group and sends it back to the order management apparatus 150 according to the customer ID of the group representative input from the order management apparatus 150.

Step #8: When the list of the group is sent back from the order information storage device 160, the order management apparatus 150 accesses the product management apparatus 130 to confirm the products.

Step #9: The product management apparatus 130 requests the provision of product information to the product information storage device 140 based on the information about the product input from the order management apparatus 150, for example, the product item ID.

Step #10: The product information storage device 140 sends back the list of the products provided to the product management apparatus 130.

Step #11: The product management apparatus 130 send the list of products received from the product information storage device 140 to the order management apparatus 150.

Step #12: The order management apparatus 150 sends the information of the list of products provided to the user portable terminal 300.

Step #13: A potential purchaser of a product looks at the information of the list of products displayed on the user portable terminal 300 to select the purchased product. When deciding the purchased product, it uses the user portable terminal 300 to apply for purchase of the product. In this case, the potential purchaser inputs its own customer ID and password to the user portable terminal 300 and sends them to the order management apparatus 150.

Step #14: The order management apparatus 150 accesses the customer management apparatus 110 and sends the customer ID and password input from the potential purchaser through the user portable terminal 300 to the customer management apparatus 110.

Step #15: The customer management apparatus 110 accesses the customer information storage device 120 to retrieve for the password stored in the customer database based on the customer ID.

Step #16: The customer information storage device 120 returns the customer's password extracted from the customer database to the customer management apparatus 110.

Step #17: The customer management apparatus 110 compares the returned customer password and the password sent from the order management apparatus 150 and, when the passwords match, confirm that the user applying for an order is the user with the customer ID and sends a sign of confirmation to the order management apparatus 150.

Step #18: The order management apparatus 150, when the customer is confirmed, sends the data of the product ordered by the user to the product management apparatus 130.

Step #19: The product management apparatus 130 accesses the product information storage device 140 to request retrieval of predetermined product information based on the item ID of the ordered product.

Step #20: The product information storage device 140, when necessary, updates the section of the product database provided. Further, it returns the product information retrieved from the product database to the product management apparatus 130.

Step #21: The product management apparatus 130 checks if there is enough stock for the quantity of the product ordered and, when an order is approved based on the result of the check, sends a sign of order approval to the order management apparatus 150.

Step #22: The order management apparatus 150 increases by one the number of persons stored in the section of the number of participants of the group list related to the representative's customer ID in the order list database in the order information storage device 160.

Step #23: The order information storage device 160 informs the order management apparatus 150 that the order list database was updated.

Step #24: The order management apparatus 150 sends information on the order approval to the user portable terminal 300 of the potential purchaser. Further, it can send a notification of order approval by mail.

The order management apparatus 150 tabulates the number of participants applying for purchase of the product for each group and calculates the priority order according to the number of participants in real time. Then, it publically discloses the number of participants of each group, the discount rate of the product price according to the number of participants, and the customer ID of the group representative through the network 400. Further, it is also possible to publically disclose the means of contacting the group representatives in accordance with their desire through the network 400. The priority order is determined before the preset deadline of the product and the result of tabulation updated at all times.

The order management apparatus 150 calculates the charge for purchase of the product after discount based on the discount rate set in advance in accordance with the number of participants in the group for each participant of the group in accordance with the result of calculation of the priority order of the number of persons in the group at the time of the deadline for solicitation and provides the product to the consumer at the calculated charge. The group representatives receive the highest discount rates in their groups.

Note that, in the above explanation, an example of calculation of the discount rate applied to each group in accordance with the number of the participants of each group was shown. Instead of the number of the group participants, the discount rate can also be set in accordance with the quantity of the product which group participants actually apply for purchase for. In this case, the highest discount rate is applied to the group ordering the most products regardless of the number of participants in the groups.

The discounted charge for the purchase of the product is notified to the participants of each group and the products are delivered to the addresses included in the personal information registered by the users. The charge for the product is collected by the payment method designated by the user, for example, deduction from a bank account, settlement by a credit card, collection through a telephone company, payment to a convenience store, or any other payment method.

Further, the method of delivery of the product may be designated by the user from delivery to a central delivery site, for example, a convenience store, or delivery to the home. Different charges may be set for the different methods of delivery. For example, when designating delivery to a convenience store, a discount can be provided from normal home delivery. Further, as an incentive, the date of the delivery of the products can be made before the date of release of the product in retail stores.

The provider of the product can increase the effect of advertising of the product and promote the spread of the product and expansion of the market by notifying consumers registered in the customer database of future schedules for release of products, information on products, etc. using distribution of information over the network 400, for example, distribution to cellular phones, transmission of e-mail, direct mail, etc.

Second Embodiment

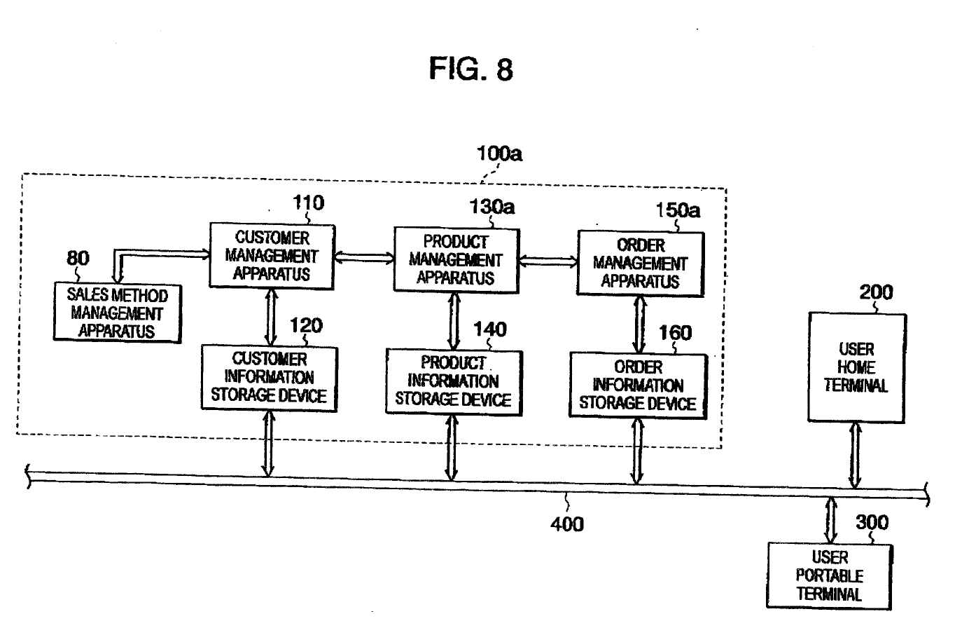

FIG. 8 is a view of the configuration of a second embodiment of a product sales system according to the present invention.

As illustrated, the product sales system of the present embodiment is comprised of a provider server 100a, a user home terminal 200, a user portable terminal 300, and a network 400. Note that in FIG. 8, only one of each of the user home terminal 200 and user portable terminal 300 is shown, but when there are a large number of users, these terminals may also be connected to the network.

The provider server 100a is a network server managed and operated by a provider of certain goods or services. It provides the users with information on the goods or services, manages customer information, and manages orders from the users. Further, the provider server 100a determines by what method of sales a product scheduled to be sold should be sold by, for example, auction sales, sales by an ordinary sales route, group discount sales through the network as explained already in the above first embodiment, or a combination of these methods. When selling by a combination of these, it decides the quantities to be sold by the respective methods of sale. The provider server 100a provides the users with sales information such as the decided methods of sales and the quantities of products scheduled to be sold by those methods through the network and stimulates the desire for purchase of the users through these activities.

The user home terminal 200 and the user portable terminal 300 are substantially the same as those disclosed in the first embodiment of the present invention explained above. That is, the user home terminal 200 is a home terminal owned by a user and is provided with a user interface and the necessary data processing function and, further, a network communications function for connecting with the network and sending and receiving the necessary information through the network. A user using a product provided by the provider side may use the user home terminal 200 to access the provider server 100a to obtain the necessary information relating to a product, search for a desired product, and apply for purchase.

The user portable terminal 300 is a portable terminal, for example, a cellular telephone, provided with the function of accessing other information terminals and an information server etc. through the network 400. A user can use the user portable terminal 300 to access the provider server 100a through the network 400 and to obtain product information, authenticate itself as a customer, input customer information, order a product, etc. through the portable terminal 300.

The network 400 consists of communication lines connected between the provider server 100a and the user home terminals 200 or the user portable terminals 300. In the present embodiment, the type of the network 400 is not particularly limited. It may be any of a usual telephone network, wireless cellular telephone network, or Internet access by a dedicated line.

Next, an explanation will be given of the configuration of the provider server 100a.

As shown in FIG. 8, the provider server 100a is comprised of a sales method management apparatus 80, a customer management apparatus 110, a customer information storage device 120, a product management apparatus 130a, a product information storage device 140, an order management apparatus 150a, and an order information storage device 160.

The sales method management apparatus 80 determines by what method a product scheduled to be sold is to be sold. The sales methods include the method of auction where a minimum purchasing price is set in advance and users place orders for the product at a purchasing price above the minimum purchasing price, the ordinary method of network sales where users place orders through the network at preset sales prices, the method of group discount sales disclosed in the first embodiment of the present invention described above, or other sales methods or combinations of these methods. When deciding on a combination of sales methods, the quantities of products assigned to the respective methods are also determined. For example, it is possible to designate the sales quantity by action as A, the sales quantity by ordinary network sales as B, and the sales quantity by group discount sales as C. Of course, the sales quantities A, B, and C assigned to the respective sales methods are determined so that S=A+B+C.

The customer management apparatus 110 manages customer information including personal information of users receiving products. The customer personal information includes, for example, a user's password, name, address, telephone number, the serial number of the user's home terminal, etc. and, when a user applies for purchase of a product, includes the method of settlement of the charge for the purchased product, for example, a bank account number, credit card number, or information indicating payment by collection agents. The customer management apparatus 110 receives applications for registration as customers from users, registers personal information of the users based on the information input by the users, and issues customer IDs to the registered users. Further, the customer management apparatus 110 creates a customer database based on the registration information and stores it in the customer information storage device 120.

The customer information storage device 120 stores the customer database created by the customer management apparatus 110. The customer information storage device 120 can add, update, or delete customer information in the customer database in accordance with instructions from the customer management apparatus 110 and can retrieve information on a predetermined customer from the customer database in accordance with instructions of the customer management apparatus 110, transfer the information on the customer corresponding to the search conditions to the customer management apparatus 110 and the order management apparatus 150a, or transfer it to other terminals or the server through the network 400.

The product management apparatus 130a manages information of the products provided by the provider. The product management apparatus 130a assembles the information on the types of products provided, prices, stock, stock period, period for receiving applications for purchase, etc. to create a product database and stores it in the product information storage device 140. Further, the product management apparatus 130a controls the updating, addition to, and deletion from the product database stored in the product information storage device 140. When there is a request from a user for information on a product, the product information storage device 140 reads out certain product information and sends it to the user. Further, in this embodiment, the product management apparatus 130a manages information such as the quantities of products assigned for each sales method by the sales method management apparatus 80 and provides that information to the user upon request.

The product information storage device 140 stores the product database created by the product management apparatus 130a. The content of the product database is updated, added to, or deleted from according to the instruction of the product management apparatus 130a. Further, it is possible to search for certain product information in response to a user's request, send the information of the corresponding product to the product management apparatus 130a, or transmit it through the network 400 directly to the user's terminal.

The order management apparatus 150a manages orders for product purchases from users. The order management apparatus 150a receives orders for products from users through the network 400, creates an order list database according to the content of orders of users, and stores it in the order information storage device 160. Moreover, the order management apparatus 150a can control the updating of, addition to, or deletion from the order list database in the order information storage device 160. Further, in this embodiment, the order management apparatus 150a obtains the sales quantities for the respective sales methods determined by the sales method management apparatus 80 from the sales method management apparatus 80 or the product management apparatus 130a, tabulates the quantities of orders by the sales methods in accordance with the sales methods designated by the users when receiving orders from users, and notifies the users of the closing of sales when the results of the tabulations show that the totals of the orders from users have reached the sales quantities assigned to the respective sales methods.

The order information storage device 160 stores the order list database managed by the order management apparatus 150a and reads out stored information and provides it to the order management apparatus 150a or another apparatus upon a request for access from the order management apparatus 150a.

Note that in the above product sales system, the sales method management apparatus 80, the customer management apparatus 110 and customer information storage device 120, the product management apparatus 130a and product information storage device 140, and the order management apparatus 150a and order information storage device 160 were described as being serially connected, but the configuration of the product sales system of this embodiment is not limited to the above configuration. The components of the system may also be connected to the network 400 in parallel. Further, the sales method management apparatus 80, the customer management apparatus 110, the customer information storage device 120, the product management apparatus 130a, the product information storage device 140, the order management apparatus 150a, and the order information storage device 160 can each be realized by individual computers or can all be realized on the same computer.

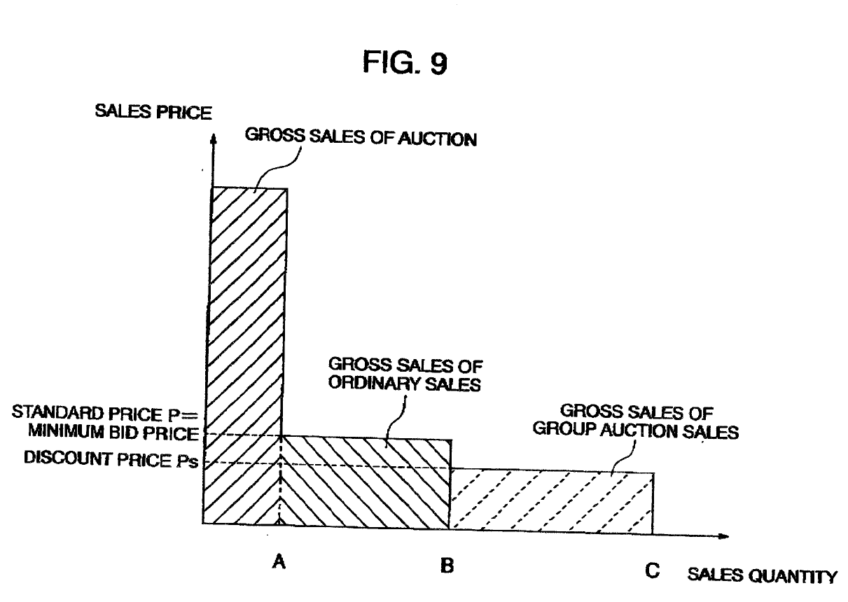

FIG. 9 is a graph of the sales prices and the sales quantities when using a combination of different sales methods. Here, three types of sales methods are used: sales by auction, ordinary sales through the network or ordinary sales through the store sales route, and group discount sales. Here, the total quantity of the products scheduled to be sold is designated as C, the sales quantity by auction as A, the sales quantity by ordinary sales methods as B-A, and the sales quantity by group discount sales as C-B. Further, in each sales method, the sales figures are determined by the sales quantities and the sales prices.

As illustrated, in the sales quantity A by auction, the standard price P set by the product provider in advance is made the minimum bid price of the auction. A user purchasing a product by auction uses the user terminal or user portable terminal to access the provider server 100a to verify itself as the customer and input its own bid price in the order management apparatus 150a. On the other hand, a user desiring to purchase a product by an ordinary sales method accesses the provider server 100a to apply for purchase by an ordinary sales method to the order management apparatus 150a. Further, a user purchasing a product using a group discount determines the group to participate in, uses the customer ID of the group representative or other group identification information, and applies for purchase by group discount sale.

The product provider provides products to users applying for purchase in accordance with these sales methods. For example, a user placing an order by a price higher than the standard price through auction sales is sent the ordered product at a timing earlier than other sales methods, while a user making a purchase by a group discount is sent the product at a delay from a user purchasing through an ordinary sales method.

Due to the above, a user making a purchase through an auction purchases a product at a bid price higher than the standard price, but can obtain the ordered product faster than by use of another sales method. Further, a user making a purchase by a group discount can purchase a product by a group discount price PS lower than the standard price, but receives the product slower than a user using another sales method.

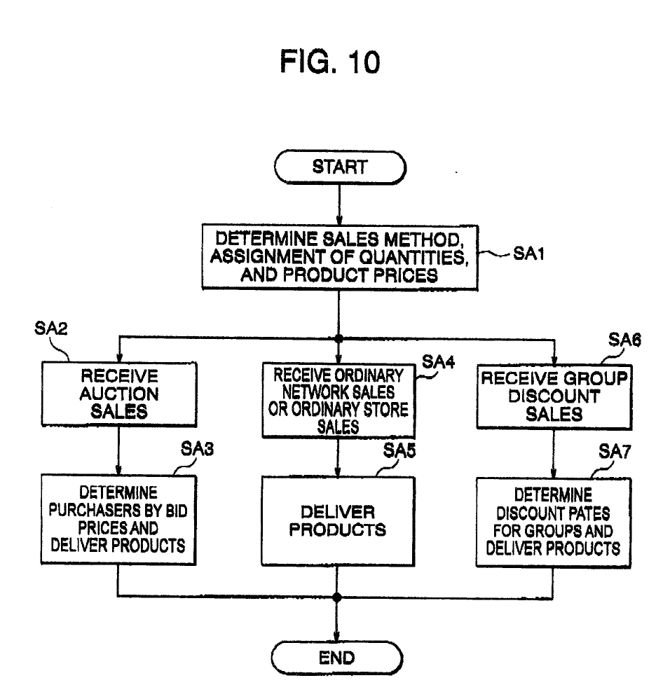

FIG. 10 is a view of the flow of the sales of a product in the product sales system of the present embodiment. Next, an explanation will be given of the flow of processing of the product sales system of the present embodiment with reference to FIG. 10.

Step SA1: First, the sales method management apparatus 80 determines the standard price for a product, that is, the minimum bid price in auction sales, the sales methods, and the sales quantities to be assigned for the sales methods. Here, for example, assume that it is decided to sell the product by three sales methods, that is, auction sales, sales by ordinary network orders, and group discount sales.

Step SA2: Orders by auction sales are received. The customer management apparatus 110 verifies the identity of the users applying for products or registers the necessary customer information and issues customer IDs in the case of new customers. Further, the order management apparatus 150a obtains the bid prices input by users through their terminals.

Step SA3: The order management apparatus 150a determines a priority order according to the bids of the users applying for purchase through auction sales at the time of the preset deadline, determines the purchasers from the top user to the sales quantity A assigned for the auction sales, and notifies the results of the auction to the users. Further, it delivers the products to the users on a predetermined date.

Step SA4: Orders from users by ordinary network sales or store sales are received. The customer management apparatus 110 verifies the users applying for products or registers the necessary customer information and issues customer IDs in the case of new customers. Further, the order management apparatus 150a obtains the quantity of purchase of the users. The ordinary network sales or store sales are ended when the quantity of orders from the users reach the assigned sales quantity B.

When reception ends, users applying for products by ordinary network orders or store orders are sent the ordered products at a timing later than the purchases of auction sales. For example, users applying for products by ordinary network orders or store orders are sent products after products have finished being delivered to all purchasers using auction sales or at a time later than that.

Step SA5: Orders from users by group discount sales are received. In this case, the customer management apparatus 110 verifies the identity of the users applying for products or registers the necessary customer information and issues customer IDs in the case of new customers. Further, it obtains group identification information for identifying the groups to which users belong, for example, the customer IDs of the group representatives.

The order management apparatus 150a obtains the quantities of purchases of the users, tabulates the purchases for each group based on the group identification information input by the users, and determines the discount rates for the groups in accordance with the number of applicants of each group or the quantities of orders of the product.

It then determines the charges for purchases calculated by the discount rates for each group for each purchaser of the groups, collects the charges, and delivers the products. Note that users ordering products by group discount sales are sent the products the latest compared with the purchasers using other sales methods.

In the product sales system of the present embodiment, the processing of the above steps SA2, SA4, and SA6 may be performed simultaneously. Alternatively, it is possible to start the reception of applications by a next sales method after sales by one sales method ends. For example, it is possible to successively start sales methods by starting to receiving sales by ordinary network orders or ordinary store sales after auction sales end and starting to receive group discount sales after sales by these methods end. Whatever the case, the users using auction sales receive their products earliest, while the purchasers using group discount sales receive their products the latest.

As explained above, according to the product sales system of the present embodiment, by selling the same product to users by different sales methods, users can purchase products by their desired sales methods and can receive different service depending on the sales methods. That is, users purchasing products at bid prices higher than the standard price through auction sales can obtain products faster than other users, while users purchasing products by group discount sales can purchase products by discount prices of group discount rates from the standard price, but receive the products slower than users of other sales methods. Due to this, when introducing a new product into the market, the product provider can secure a higher profit than with conventional sales methods through auction sales and can provide products to users at lower prices through ordinary network order sales or store sales or through group discount sales and therefore can help expand the market. In particular, it can therefore secure sufficient profit at the time of initial stage after release. This has the effect of promoting new product development in the provider and the desire for purchase of consumers.

Third Embodiment

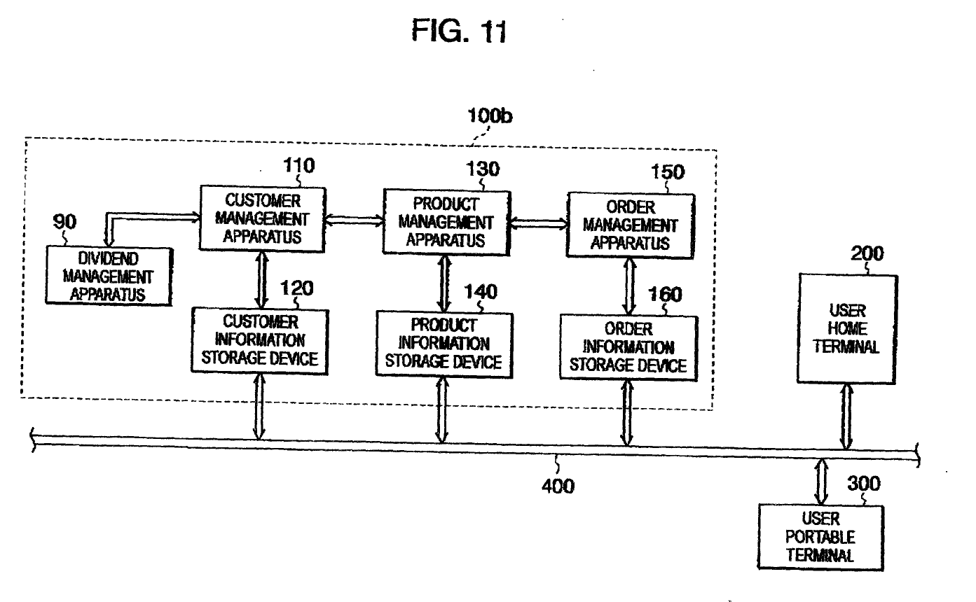

FIG. 11 is a view of the configuration of a third embodiment of a product sales system according to the present invention.

As illustrated, the product sales system of the present embodiment is comprised of a provider server 100b, a user home terminal 200, a user portable terminal 300, and a network 400. Note that in FIG. 11, only one of each of the user home terminal 200 and user portable terminal 300 is shown, but when there are a large number of users, these terminals may also be connected to the network.

The provider server 100b is a network server managed and operated by a provider of certain goods or services. It provides the users with information on the goods or services, manages customer information, and manages orders from the users. Further, the provider server 100b determines the sales methods and sales quantities etc. of the product scheduled to be sold and provides the users with sales information such as the decided methods of sales and the quantities of products scheduled to be sold by those methods through the network and stimulates the desire for purchase of the users through these activities.

The user home terminal 200 and the user portable terminal 300 are substantially the same as those disclosed in the first and second embodiments of the present invention explained above. A user may use the these terminals to access the provider server 100b to obtain the necessary information relating to a product, search for a desired product, and apply for purchase.

The network 400 consists of communication lines connected between the provider server 100b and the user home terminals 200 or the user portable terminals 300. In the present embodiment, the type of the network 400 is not particularly limited. It may be any of a usual telephone network, wireless cellular telephone network, or Internet access by a dedicated line.

Next, an explanation will be given of the configuration of the provider server 100b.

As shown in FIG. 11, the provider server 100b is comprised of a dividend management apparatus 90, a customer management apparatus 110, a customer information storage device 120, a product management apparatus 130b, a product information storage device 140, an order management apparatus 150b, and an order information storage device 160.

The dividend management apparatus 90 manages the issuance of dividends to purchases in accordance with the profit obtained by the sale of a product. For example, it issues a predetermined dividend to users purchasing products of an initial shipment when the total profit of the product reaches a preset value. Here, a purchaser eligible for a dividend may be made a purchaser of a product of an initial shipment or a purchaser purchasing a product before a preset initial sales quantity is reached or may be limited to auction product purchasers purchasing products by bid prices higher than the standard price through auction sales among the products of the initial shipment. By purchasing products shipped at the initial stage of merchandising, these purchasers may receive products inferior in performance compared with later shipments due to later improvements. Further, while they receive the benefit of being able to obtain products on a priority basis from other purchasers, particularly when purchasing products through auction sales, they purchase the products at prices above the standard price, so the amount of the purchases over the standard price can be considered investment in initial market development. The product provider can improve the quality of service by returning part of the profit to these purchasers in the form of dividends.

The type of the dividend may be cash dividends and also product certificates, discounts, free upgrades of products, free or discounted prices of peripherals, etc. Further, the timing of the issuance of the dividends can be set by the provider for example, as explained above, to the time when the total profit of a product reaches a preset value or the time when the number of units of the product sold reaches a preset level. Further, the dividend is not limited to a single dividend. For example, a first dividend can be issued when the total profit reaches a first target and a second dividend issued when gross sales further steadily rise and the total profit reaches a second target. The issuance of dividends is managed by the dividend management apparatus 90. The dividend management apparatus 90 discloses the method of issuing dividends preset by the provider, the value of dividends, the target for profits for issuing dividends, and other dividend information to the users to stimulate the desire for purchase.

Note that the information required for issuing dividends, for example, the list of purchasers eligible for dividends and the identification information of products purchased by purchasers, for example, the manufacturing serial numbers of the products, and other information are stored in the storage devices managed by the divided management apparatus 90. Further, the information can be created and managed by the order management apparatus 15. In this case, it is possible to store the list of persons eligible for dividends and identification information of products purchased by purchasers in the order information storage device 160.

In the provider server 100b of the present embodiment, the customer management apparatus 110, the customer information storage device 120, the product management apparatus 130b, the product information storage device 140, the order management apparatus 150b, and the order information storage device 160 have substantially the same configurations and functions as the components of the provider server 100a of the second embodiment of the present invention explained above.

In the present embodiment, however, the dividend management apparatus 90 stores dividend information for issuing dividends. Further, the product management apparatus 130b and order management apparatus 150b provide the necessary information to prepare and manage the dividend information. For example, the product management apparatus 130b manages the identification information of the products sold, for example, the manufacturing serial numbers, product IDs, etc. of the products. The order management apparatus 150b manages not only information such as the methods of purchase and methods of payment of the purchasers when receiving orders for products from users, but also identification information of products delivered to the purchasers when delivering the products. The order management apparatus 150b links purchaser identification information, for example, the customer IDs, and identification information of the products purchased by the purchasers to create dividend information for each purchaser and stores the created information in the order information storage device 160.

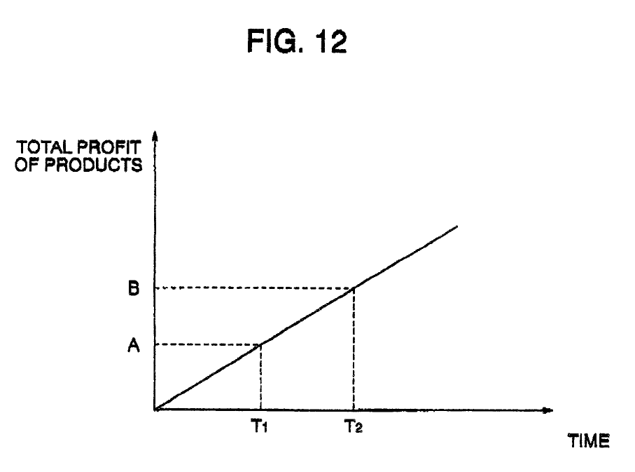

FIG. 12 is a graph of the total profit of a product and the time for issuance of a dividend. Here, the case is shown where, for example, the first dividend is issued when the total profit reaches a preset target A and the second dividend is issued when the total profit reaches a preset target B.

As illustrated, after the start of sale of a product, the gross sales rise along with time. The total profit rises as well. The total profit reaches the target A at the time T1. The first dividend is issued at that time. Next, the gross sales further grow and the target B is reached at the time T2, so the second dividend is issued.

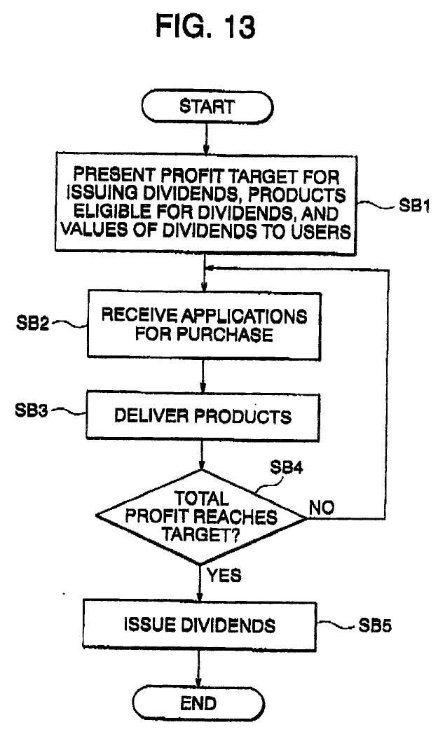

FIG. 13 is a flow chart of the processing in the dividend management apparatus 90 managing the above dividend. Next, an explanation will be made of the operation of the dividend management apparatus 90 with reference to the flow chart.

Step SB1: First, the dividend management apparatus 90 provides the user with profit targets for issuance of dividends, the quantity of products covered by the dividends, the value of the dividends, etc. through the network 400.

Step SB2: Applications for purchase are received from purchasers. The customer management apparatus 110 verifies the identity of the applying users or registers the necessary customer information and issues customer IDs in the case of new customers. Further, the order management apparatus 150b obtains information on the method of purchase from the users etc. For example, when the user desires a purchase by auction sales, it obtains the bid prices of the users, while when the user desires a purchase by another method, it obtains the necessary information accordingly.

Step SB3: The products are delivered to the users ordering the products. Here, the manufacturing serial numbers or other identification information of the products delivered to the users re linked with the identification information of the users, for example, the customer IDs, to generate dividend information. This dividend information is created by for example the order management apparatus 150b. The created dividend information is stored in the order information storage device 160.

Step SB4: The dividend management apparatus 90 judges if the total profit of the product has reached a preset target.

Step SB5: When the total profit of the product reaches the target, the apparatus issues dividends to eligible persons in accordance with the preset dividend method and value of dividends.

Note that when issuing dividends several times in accordance with a plurality of preset targets, the processing shown in step SB4 and SB5 is performed for each target.

In the product sales system of the present embodiment, due to the above processing, the dividend management apparatus 90 monitors the total profit of the product and issues a dividend when the total profit reaches a predetermined target value. Further, instead of the total profit of the product, it is also possible to preset a dividend target in accordance with the gross sales of the product, the number of units sold, etc. and issue dividends in accordance with those targets. Therefore, it is possible to realize a growth rate of sales higher than the conventional sales method at the initial stage after release of a product and increase the market in a short time.

The sales methods of the product sales system of the present invention may be independently applied. It is also possible to combine a plurality of sales methods. For example, it is possible to combine auction sales, ordinary network order sales, and group discount sales as disclosed in the second embodiment and issue dividends in accordance with the total profit as disclosed in the third embodiment to the purchasers of products by auction sales. Further, the persons receiving dividends are not limited to ones using auction sales. It is also possible to issue dividends for all products of the initial shipment.

Summarizing the effects of the invention, as explained above, according to the product sales server, product sales system, and sales method of the present invention, a provider of a product can use the network to promote a product and increase its market. Consumers can contribute to the promotion of sales of the product and obtain products more economically by working as group representatives, working to increase the number of group participants, etc. for purchase of the product at a greater discount rate. As a result of consumers forming groups to compete for discount rates for products, the consumers themselves can contribute to the spread of the product and increase of the market. Further, product providers can set and publically disclose discount rates in advance in accordance with sales quantities to acquire repeat customers.

Further, according to the present invention, it is possible to sell the same product by a plurality of sales methods and for consumers to purchase products by their desired sales methods and obtain different services by the different sales methods. For example, when purchasing a product by auction sales, a consumer can obtain the product faster than other users. Further, when purchasing a product by group discount sales, a consumer can purchase a product by a discount price cheaper than the standard price. Further, by issuing a dividend to the purchasers of initially sold products based on preset dividend terms, sales of a product can be promoted and the market can be increased.

While the invention has been described with reference to specific embodiment chosen for purpose of illustration, it should be apparent that numerous modifications could be made thereto by those skilled in the art without departing from the basic concept and scope of the invention.

The present disclosure relates to subject matter contained in Japanese Patent Application No. 2000-117201, filed on Apr. 13, 2000, the disclosure of which is expressly incorporated herein by reference in its entirety.

What is claimed is:

1. A product sales server for selling a product to consumers divided into a plurality of groups by using a network, comprising:
an order management means for receiving applications for purchase of the product from the consumers, verifying the identity of the consumers by identification information input from the consumers, and confirming the method of payment of the charge of purchase to the verified consumers and
a charge calculation means for tabulating the number of the product purchasers for each group in accordance with group identification information showing the group to which consumers belong and setting discount rates for each group according to the number of purchasers.

2. A product sales server as set forth in claim 1, further comprising:
a product information storage means for storing information about the product provided by provider of the product and
a product information management means for managing the product information and sending the product information to the consumers through the network in response to requests of the consumers.

3. A product sales server as set forth in claim 1, further comprising:
a customer information storage means for storing customer information including at least a customer identification number and a PIN number linked with each consumer and
a customer information management means for managing the customer information and providing the customer information in response to a request of the order management means.

4. A product sales server as set forth in claim 3, wherein the order management means includes a customer verification means for having the customer information storage means retrieve a PIN number linked with a customer identification number in accordance with the customer identification number among the customer identification number and the PIN number input by the consumer when receiving an application for purchase from the customer, comparing the retrieved PIN number with the PIN number input from the consumer, and verifying the identity of the consumer.

5. A product sales server as set forth in claim 1, wherein the order management means accepts applications for purchase of a product up to a preset deadline.

6. A product sales server as set forth in claim 1, wherein the charge calculation means tabulates the number of purchasers of each group and publically discloses the results of tabulation over the network.

7. A product sales server as set forth in claim 1, wherein the charge calculation means calculates a delivery charge according to a method of delivery designated by each consumer.

8. A product sales server as set forth in claim 1, wherein the charge calculation means applies a discount rate to a representative of each group higher than the group members other than the representative.

9. A product sales server for selling a product to consumers divided into a plurality of groups by using a network, comprising:
an order management means for receiving applications for purchase of the product from said consumers, verifying the identity of the consumers by identification information input from the consumers, and confirming the quantity of purchase of the product and the method of payment of the charge of purchase to the verified consumers and
a charge calculation means for tabulating the quantity of purchase of the product for each group in accordance with group identification information showing the group to which consumers belong and setting discount rates for each group according to the quantity of purchases.

10. A product sales server as set forth in claim 9, further comprising:
a product information storage means for storing information relating to the product provided by the provider of the product and
a product information management means for managing product information and sending the product information to the consumer through the network in response to a request of the consumer.

11. A product sales server as set forth in claim 9, further comprising:
a customer information storage means for storing customer information linked with each consumer and including at least a customer identification number and a PIN number and
a customer information management means for managing the customer information and providing the customer information in response to a request of the order management means.

12. A product sales server as set forth in claim 11, wherein the order management means includes a customer verification means for having the customer information storage means retrieve a PIN number linked with a customer identification number in accordance with the customer identification number among the customer identification number and the PIN number input by the consumer when receiving an application for purchase from the customer, comparing the retrieved PIN number with the PIN number input from the consumer, and verifying the identity of the consumer.

13. A product sales server as set forth in claim 9, wherein the order management means accepts applications for purchase of a product up to a preset deadline.

14. A product sales server as set forth in claim 9, wherein the charge calculation means tabulates the quantity of purchases of products of each group and publically discloses the results of tabulation over the network.

15. A product sales server as set forth in claim 9, wherein the charge calculation means calculates a delivery charge according to a method of delivery designated by each consumer.

16. A product sales server as set forth in claim 9, wherein the charge calculation means applies a discount rate to a representative of each group higher than the group members other than the representative.

17. A product sales server for selling a product by using a network, comprising:
a sales method management means for determining at least a first sales method and a second sales method and assigning a first sales quantity for sale by the first sales method and a second sales quantity for sale by the second sales method in the products being sold and
an order management means for receiving applications for products from users, obtaining purchase prices from users purchasing the product by the first sales method, determining the purchasers of the product in accordance with the purchase prices of the users, and delivering the product to the users purchasing by the first sales method at a time earlier than users purchasing the product by the second sales method.

18. A product sales server as set forth in claim 17, wherein
the first sales method is auction sales and
the order management means determines the priority order of the users ordering the product by auction sales in accordance with the purchase prices submitted by the users and ends the sale by the first sales method when the total number of orders reaches the first sales quantity assigned by the sales method management means.

19. A product sales server as set forth in claim 17, wherein
the second sales method is group discount sales, and
the order management means tabulates the quantity of orders for the product for each group to which users belong and sets discount rates for each group according to the result of tabulation for users ordering the product by the second sales method.

20. A product sales server for selling a product by using a network, comprising:
an order management means for receiving applications for purchase of the product from users and
a dividend management means for issuing a dividend based on a predetermined amount to users purchasing the product when the total profit obtained by the sale of the product reaches a preset target.

21. A product sales server as set forth in claim 20, wherein the dividend management means issues the dividend to users purchasing products of the initial shipment of the products.

22. A product sales server as set forth in claim 20, wherein the dividend management means issues a dividend to the users purchasing the product by auction sales.

23. A product sales server as set forth in claim 20, wherein the dividend management means provides a discount service corresponding to the value of the dividend to the purchasers of the product.

24. A product sales server as set forth in claim 20, wherein the dividend management means issues a first dividend to the purchasers of the product when the total profit from the sale of the product reaches a preset first target and issues a second dividend to the purchasers of the product when the total profit reaches a predetermined second target.

25. A product sales system for selling a product to a plurality of consumers by using a network, comprising:
a user terminal, connected to the network, by which a consumer desiring to purchase the product applies for a purchase,
an order management means for receiving applications for purchase of the product from the consumers, verifying the identity of the consumers by identification information input by the consumers, and confirming the method of payment of the charge for the purchase to the verified consumers, and
a charge calculation means for tabulating the number of the purchasers of the product in each group according to group identification information showing the group to which the consumers belong and setting discount rates for each group according to the number of the purchasers.

26. A product sales system for selling a product to a plurality of consumers by using a network, comprising:
a user terminal, connected to the network, by which a consumer desiring to purchase the product applies for a purchase,
an order management means for receiving applications for purchase of the product from the consumers, verifying the identity of the consumers by identification information input by the consumers, and confirming the method of payment of the charge for the purchase to the verified consumers, and
a charge calculation means for tabulating the quantity of purchases of the product in each group according to group identification information showing the group to which the consumers belong and setting discount rates for each group according to the quantity of purchases of the product.

27. A product sales system for selling a product by using a network, comprising:
a sales method management means for determining at least a first sales method and a second sales method and assigning a first sales quantity for sale by the first sales method and a second sales quantity for sale by the second sales method in the product to be sold and
an order management means for receiving applications from users, obtaining purchase prices from users purchasing the product by the first sales method, determining the purchasers of the product in accordance with the purchase prices of the users, and delivering the product to the users purchasing by the first sales method at a time earlier than users purchasing the product by the second sales method.

28. A product sales system for selling a product by using a network, comprising:
an order management means for receiving applications for purchase of the product from users and
a dividend management means for issuing a dividend based on a predetermined amount to users purchasing the product when the total profit obtained by the sale of the product reaches a preset target.

29. A product sales method by which a product sales server sales a product to a plurality of consumers by using a network, comprising:
a step of having the product sales server receive applications for purchase of the product from said consumers through the network,
a step of verifying the identity of the consumers by identification information input from the consumers and confirming the method of payment of the charge of purchase to the verified consumers, and
a step of tabulating the number of the product purchasers for each group in accordance with group identification information showing the group to which consumers belong and setting discount rates for each group according to the number of purchasers.

30. A product sales method by which a product sales server sales a product to a plurality of consumers by using a network, comprising:
a step of having the product sales server receive applications for purchase of the product from said consumers through the network,
a step of verifying the identity of the consumers by identification information input from the consumers and confirming the quantity of purchases of the product and method of payment of the charge of purchase to the verified consumers, and
a step of tabulating the quantity of product purchases for each group in accordance with group identification information showing the group to which consumers belong and setting discount rates for each group according to the quantity of purchases.

31. A product sales method by which a product sales server sales a product to a plurality of consumers by using a network, comprising:
a step of determining at least a first sales method and a second sales method and assigning a first sales quantity for sale by the first sales method and a second sales quantity for sale by the second sales method in the products being sold and
a step of receiving applications for products from users, obtaining purchase prices from users purchasing the product by the first sales method, determining the purchasers of the product in accordance with the purchase prices of the users, and delivering the product to the users purchasing by the first sales method at a time earlier than users purchasing the product by the second sales method.

32. A product sales method by which a product sales server sales a product to a plurality of consumers by using a network, comprising:
a step of receiving applications for purchase of the product from users and
a step of issuing a dividend based on a predetermined amount to users purchasing the product when the total profit obtained by the sale of the product reaches a preset target.
